(19) United States
(12) Patent Application Publication
(10) Pub. No.: US 2018/0174150 A1
(43) Pub. Date: Jun. 21, 2018

(54) SYSTEMS AND METHODS FOR PROCESSING A PAYMENT TRANSACTION AUTHORIZATION REQUEST

(71) Applicant: MASTERCARD INTERNATIONAL INCORPORATED, Purchase, NY (US)

(72) Inventor: Subrat Das, Madhupatna Thana (IN)

(21) Appl. No.: 15/816,023

(22) Filed: Nov. 17, 2017

(30) Foreign Application Priority Data
Dec. 20, 2016 (SG) 10201610686S

(51) Int. Cl. G06Q 20/40; G06Q 20/12; G06K 9/00

(52) U.S. Cl. CPC G06Q 20/40145; G06Q 20/12; G06Q 2220/00; G06K 9/00892; G06Q 20/4016

(57) ABSTRACT

A data processing device for generating a transaction authorization request is disclosed. The data processing device includes an input module operable to receive a user input from a user, a camera module operable to capture an image of the user, a computer processor, and a data storage device, the data storage device having an input processing component, a camera control component, and a transaction request generation component including non-transitory instructions operative by the processor to receive a user input from a user indicating initiation of a transaction, control the camera module to capture an image of the user, and generate a transaction authorization request, the transaction authorization request including an indication of the transaction and the image of the user.

### CROSS REFERENCE TO RELATED APPLICATIONS

This patent application claims priority to Singapore Application No. 10201610686S filed on Dec. 20, 2016, the disclosure of which is incorporated by reference herein in its entirety as part of the present application.

### BACKGROUND

The present disclosure relates to payment transactions. In particular, it provides systems and methods for generating and processing transaction authorization requests generated during mobile commerce or electronic commerce transactions.

Mobile commerce and electronic commerce have seen rapid growth in recent years. Mobile commerce and electronic commerce transactions usually include some form of authentication to identify fraudulent transactions. If a mobile device or portable computer is stolen it may be used to carry out fraudulent transactions. In such circumstances, once the device is identified as stolen, the transactions can be identified as fraudulent and future fraudulent transactions originating from that device can be blocked. However, it is often that case that the same individuals may initiate fraudulent transactions using different devices. Using information such as user names, or device identifiers it is difficult to immediately identify such transactions as fraudulent.

### BRIEF DESCRIPTION

In general terms, the present disclosure provides systems and methods for generating and processing transaction authorization requests. During the generation of a transaction authorization request on a user device such as a mobile device or a portable computer an image of the user is captured using a camera module of the device. This image is included in a transaction authorization request. During processing of the transaction authorization request, the image is stored as part of a transaction record. This transaction record may be reviewed later to identify the user who initiated a transaction which is suspected of being fraudulent. Additionally, in some embodiments the captured image of the user who initiated the transaction authorization request is compared with images captured during fraudulent transactions to identify whether the user matches a user involved in previous transactions which are suspected of being fraudulent. In such circumstances the transaction authorization request may be declined.

A first aspect of the present disclosure provides a data processing device for generating a transaction authorization request. The data processing device may be for example a smart phone device, a tablet device or a laptop computer. The data processing device includes an input module operable to receive a user input from a user, a camera module operable to capture an image of the user, a computer processor, and a data storage device, the data storage device having an input processing component, a camera control component, and a transaction request generation component including non-transitory instructions operative by the processor to receive a user input from a user indicating initiation of a transaction, control the camera module to capture an image of the user, and generate a transaction authorization request, the transaction authorization request including an indication of the transaction and the image of the user.

In an embodiment the transaction request generation component further includes non-transitory instructions operative by the processor to generate authentication information for the user and wherein the transaction authorization request further includes an indication of the authentication information.

In an embodiment the data processing device further includes a biometric reader module and wherein the transaction request generation component further includes non-transitory instructions operative by the processor to generate authentication information by controlling the biometric reader module to capture biometric data of the user.

In an embodiment the transaction request generation component further includes non-transitory instructions operative by the processor to generate authentication information using authentication input by the user into the input module.

In an embodiment the data storage device further including an image analysis component includes non-transitory instructions operative by the processor to analyze the image of the user to determine if the image corresponds to a living human, and wherein the transaction request generation component includes non-transitory instructions operative by the processor to generate the transaction authorization request only if the image corresponds to a living human.

In an embodiment the camera control component further includes non-transitory instructions operative by the processor to control the camera to capture the image of the user in response to the user input indicating initiation of the transaction.

In an embodiment the input processing component further includes non-transitory instructions operative by the processor to receive input of a user identifier, and wherein the transaction authorization request further includes an indication of the user identifier.

In an embodiment the data processing device further includes a communication module, and the data storage device further includes an communication control component including non-transitory instructions operative by the processor to send the transaction authorization request to a transaction processing server from the communication module.

A second aspect of the present disclosure provides a method of generating a transaction authorization request in a data processing device. The method includes receiving, in an input module of the data processing device, a user input from a user indicating initiation of a transaction, capturing, in a camera module of the data processing device, an image of the user, generating, in a transaction authorization request generation component of the data processing device, a transaction authorization request, the transaction authorization request including an indication of the transaction and the image of the user.

A third aspect of the present disclosure provides a system for processing a transaction authorization request. The system includes a computer processor and a data storage device, the data storage device having a transaction request processing component, and a transaction record storage component including non-transitory instructions operative by the processor to receive, a transaction authorization request, the transaction authorization request including an indication of a transaction and an image of a user captured during initiation of the transaction authorization request, and store, in a database coupled to the system, a transaction record including the image of the user and the indication of the transaction.

In an embodiment the transaction authorization request further includes an indication of a user identifier, and the transaction record further includes an indication of the user identifier.

In an embodiment the data storage device further includes an image comparison component including non-transitory instructions operative by the processor to compare the image of the user captured during initiation of the transaction authorization request with at a plurality of stored images labeled as relating to fraudulent transactions, and the transaction request processing component further includes non-transitory instructions operative by the processor to generate a transaction authorization response indicating that the transaction is declined if the image of the user captured during indication matches one of the images labeled as relating to a fraudulent transaction.

In an embodiment the transaction record storage component further includes non-transitory instructions operative by the processor to encrypt the transaction record.

A fourth aspect of the present disclosure provides a computer implemented method of processing a transaction authorization request. The method includes receiving, at a payment transaction processing server, a transaction authorization request, the transaction authorization request including an indication of a transaction and an image of a user captured during initiation of the transaction authorization, request, storing in a database coupled to the payment transaction server, a transaction record including the image of the user and the indication of the transaction.

A further aspect provides a non-transitory computer-readable medium. The computer-readable medium has stored thereon program instructions for causing at least one processor to perform operations of a method disclosed above.

### BRIEF DESCRIPTION OF THE DRAWINGS

Embodiments of the disclosure will now be described for the sake of non-limiting example only, with reference to the following drawings in which:

FIG. 1 is a block diagram of a data processing system according to an embodiment of the present disclosure;

FIG. 2 is a block diagram illustrating a technical architecture of a user device according to an embodiment of the present disclosure;

FIG. 3 is a block diagram illustrating a technical architecture of a transaction processing server according to an embodiment of the present disclosure;

FIG. 4 is a flowchart showing a method of generating a transaction authorization request according to an embodiment of the present disclosure; and

FIG. 5 is a flowchart showing a method of processing a transaction authorization request according to an embodiment of the present disclosure.

### DETAILED DESCRIPTION

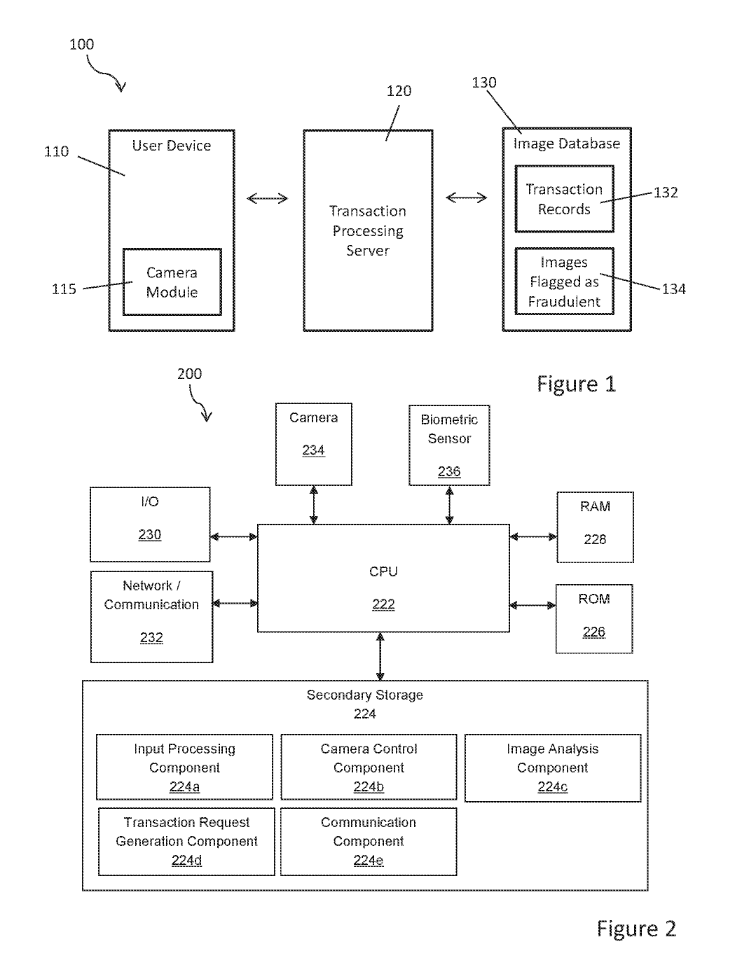

FIG. 1 is a block diagram showing a data processing system 100 according to an embodiment of the present disclosure. The data processing system includes a user device 110, a transaction processing server 120, and an image database 130.

The user device 110 may be a mobile computing device such as a smart phone, tablet device, or laptop computer. The user device 110 includes a camera module 115 which is operable to capture images such as an image of a user of the device. The user device 110 can communicate with the transaction processing server 120 via a network such as the internet or other communications network. The transaction processing server 120 is operable to process payment transactions initiated on the user device 110. The transactions initiated on the user device 110 may be internet transactions or mobile payment transactions made through a merchant application running on the user device 110.

The image database 130 is coupled to the transaction processing server 120 and stores transaction records 132 and images which are flagged as fraudulent 134. The transaction records 132 include data on transactions and include images captured during transactions, for example images captured by the camera module 115 of the user device 110 during the initiation of a transaction. The images flagged as fraudulent 134 are images captured during transactions which have been identified as fraudulent.

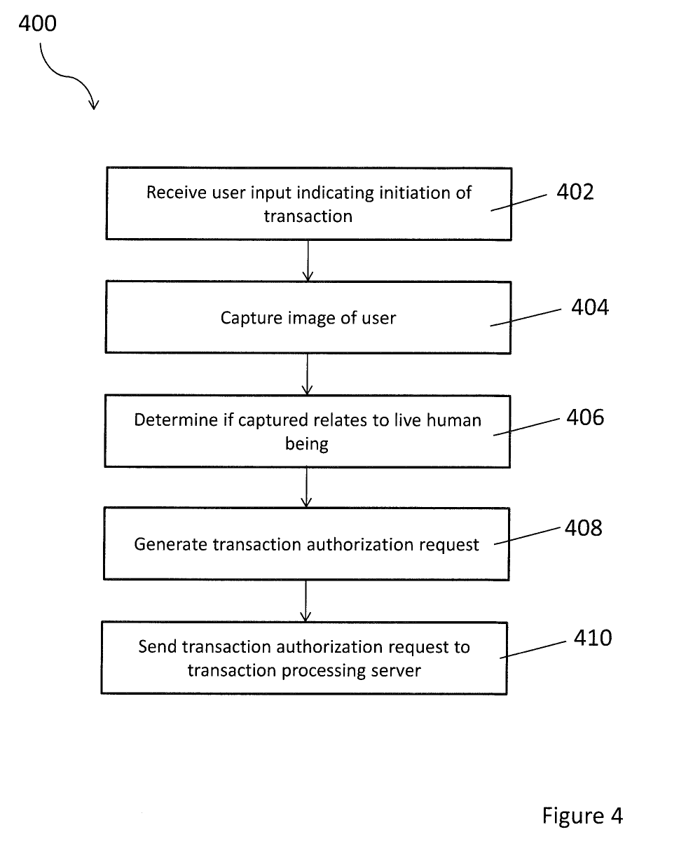

FIG. 2 is a block diagram showing a technical architecture 200 of the user device 110 for performing an exemplary method 400 is described below with reference to FIG. 4. Typically, the method 400 is implemented by a computer having a data-processing unit. The block diagram as shown in FIG. 2 illustrates a technical architecture 200 of a device such as a computer, smart phone, or tablet device which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 200 may further include input/output (I/O) devices 230, and network connectivity and communication devices 232, a camera module 234, and a biometric sensor 236, such as a fingerprint sensor.

The secondary storage 224 typically includes one or more disk drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has an input processing component 224a, a camera control component 224b, an image analysis component 224c, a transaction request generation component 224d, and a communication component 224e including non-transitory instructions operative by the processor 222 to perform various operations of the method of the present disclosure. As shown in FIG. 2, the components 224a-224e are distinct modules which perform respective functions implemented by the electronic commerce analysis server 200. It will be appreciated that the boundaries between these components are exemplary only, and that alternative embodiments may merge components or impose an alternative decomposition of functionality of components. For example, the components discussed herein may be decomposed into sub-components to be executed as multiple computer processes, and, optionally, on multiple computers. Moreover, alternative embodiments may combine multiple instances of a particular component or sub-component. It will also be appreciated that, while a software implementation of the components 224a-224e is described herein, these may alternatively be implemented as one or more hardware modules (such as field-programmable gate array(s) or application-specific integrated circuit(s)) including circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity and communication devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

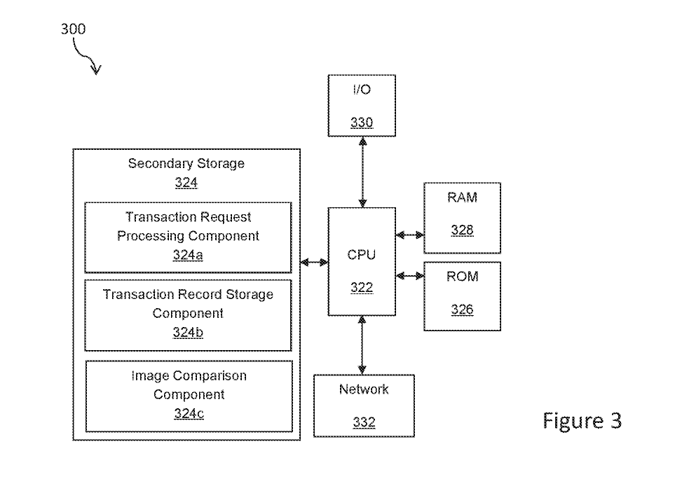

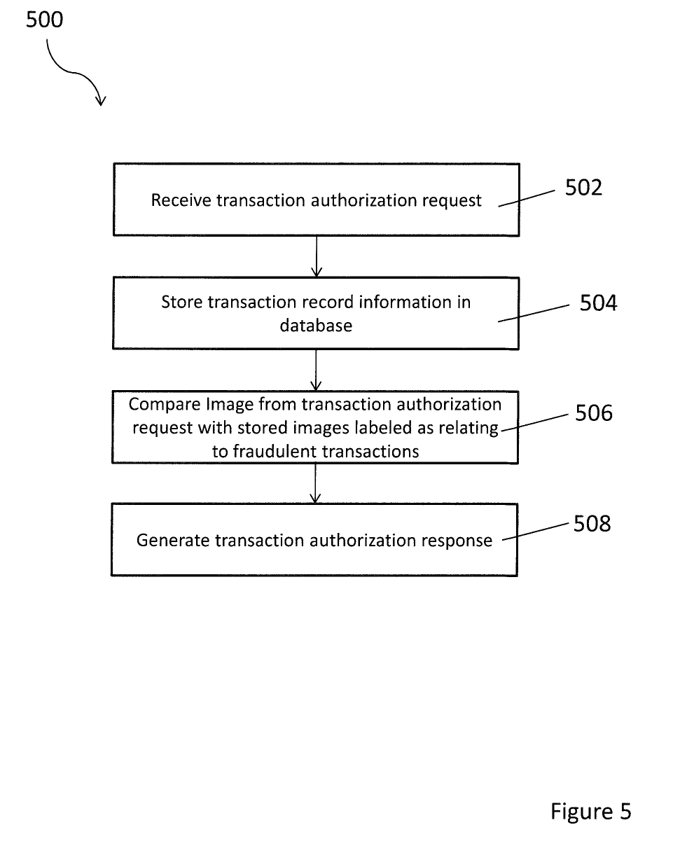

FIG. 3 is a block diagram showing a technical architecture 300 of the server of the transaction processing server 120 for performing an exemplary method 500 described below with reference to FIG. 5. Typically, the method 500 is implemented by a computer having a data-processing unit. The block diagram as shown in FIG. 3 illustrates a technical architecture 300 of a computer which is suitable for implementing one or more embodiments herein.

The technical architecture 300 includes a processor 322 (which may be referred to as a central processor unit or CPU) that is in communication with memory devices including secondary storage 324 (such as disk drives), read only memory (ROM) 326, and random access memory (RAM) 328. The processor 322 may be implemented as one or more CPU chips. The technical architecture 300 may further include input/output (I/O) devices 330, and network connectivity devices 332.

The secondary storage 324 typically includes one or more disk drives or tape drives and is used for non-volatile storage of data and as an over-flow data storage device if RAM 328 is not large enough to hold all working data. Secondary storage 324 may be used to store programs which are loaded into RAM 328 when such programs are selected for execution. In this embodiment, the secondary storage 324 has a transaction request processing component 324a, a transaction record storage component 324b, and an image comparison component 324c including non-transitory instructions operative by the processor 322 to perform various operations of the method of the present disclosure. As shown in FIG. 3, the components 324a-324c are distinct modules which perform respective functions implemented by the electronic commerce analysis server 300. It will be appreciated that the boundaries between these components are exemplary only, and that alternative embodiments may merge components or impose an alternative decomposition of functionality of components. For example, the components discussed herein may be decomposed into sub-components to be executed as multiple computer processes, and, optionally, on multiple computers. Moreover, alternative embodiments may combine multiple instances of a particular component or sub-components. It will also be appreciated that, while a software implementation of the components 324a-324c is described herein, these may alternatively be implemented as one or more hardware components (such as field-programmable gate array(s) or application-specific integrated circuit(s)) including circuitry which implements equivalent functionality to that implemented in software. The ROM 326 is used to store instructions and perhaps data which are read during program execution. The secondary storage 324, the RAM 328, and/or the ROM 326 may be referred to in some contexts as computer readable storage media and/or non-transitory computer readable media.

I/O devices 330 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Although the technical architecture 300 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 300 to provide the functionality of a number of servers that is not directly bound to the number of computers in the technical architecture 300. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 300, at least one of the CPU 322, the RAM 328, and the ROM 326 are changed, transforming the technical architecture 300 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of an exemplary method 400 will now be described with reference to FIG. 4 in respect of generating a transaction authorization request. It should be noted that enumeration of operations is for purposes of clarity and that the operations need not be performed in the order implied by the enumeration.

In step 402, the input processing component 224a of the user device 110 receives an input indicating initiation of a transaction. Step 402 may involve the user of the user device 110 opening an application for example a merchant app and adding items to a shopping cart provided by the app. Thus the initiation of the transaction may involve the user initiating a check out option in the app and selecting payment details.

In some embodiments, step 402 may further includecapturing authentication information of the user by the user device 110. This may involve capture of biometric data of the user by the biometric sensor 236 of the user device, or the input of authentication information such as a PIN number of password by the user into the user device.

In step 404, the camera control component 224b of the user device 110 controls the camera module 115 of the user device 110 to capture an image of the user. In some embodiments the capture of the image of the user occurs automatically in response to the input indicating initiation of the transaction. Thus, the camera control component 224b of the user device may control the camera module 115 of the user device 115 to capture the image of the user in response to the user input indicating initiation of the transaction.

In step 406, the image analysis component 224c of the user device 110 determines whether the captured image relates to a live human being. Step 406 may be implemented by monitoring a video sequence of the user and determining that the sequence relates to a live human after an activity such a one or two blinks of the eye have occurred.

If the image is determined to relate to a live human being in step 406, the method continues to steps 408 and 410. If the image is identified not to relate to a live human being, then the method may be halted and a notification provided to the user. In some embodiments, the method may prompt the user allow another image to be captured. Thus, if one attempt at capturing an image the user may have a second opportunity to capture an image.

In step 408 the transaction request generation component 224d of the user device 110 generates a transaction authorization request. The transaction authorization request includes an indication of the details of the transaction, for example the total transaction amount, details of a payment card account or an indication of a payment card account of the user, and the image of the user. In some embodiments, the transaction authorization request also includes the authentication information of the user.

In step 410, the communication component 224e of the user device 110 controls the network connectivity and communication devices 232 of the user device to send the transaction authorization request to the transaction processing server 120.

Various operations of an exemplary method 500 will now be described with reference to FIG. 5 in respect of processing a transaction authorization request. It should be noted that enumeration of operations is for purposes of clarity and that the operations need not be performed in the order implied by the enumeration.

In step 502, transaction request processing component 324a of the transaction processing server 120 receives a transaction authorization request from the user device 110. As described above with reference to FIG. 4, the transaction authorization request includes an image of the user captured during initiation of the transaction authorization request.

In step 504, the transaction record storage component 324b of the transaction processing server 120 generates transaction record information which includes an indication of the transaction and the image captured during initiation of the transaction. The indication of the transaction includes, for example, date and time information of the transaction and an indication of the amount of the transaction. The transaction record storage component 324b stores the transaction record information in the image database 130 as part of transaction records 132.

In step 506, the image comparison component 324c of the transaction processing server 120 compares the image captured during initiation of the transaction authorization request with images flagged as fraudulent 134 stored in the image database 130.

In step 508, the transaction request processing component 324a of the transaction processing server 120 generates a transaction authorization response. If in step 506, it is determined that the image captured during the initiation of the transaction authorization request then the transaction authorization response generated in step 508 indicates that the transaction is declined. Further authentication of the transaction authorization request may also be carried out such as checking account balance and credit limit details associated with the user account before a transaction authorization response is generated in step 508.

Whilst the foregoing description has described exemplary embodiments, it will be understood by those skilled in the art that many variations of the embodiment can be made within the scope and spirit of the present disclosure.

1. A data processing device for generating a transaction authorization request, the data processing device comprising:
an input module operable to receive a user input from a user;
a camera module operable to capture an image of the user;
a computer processor; and
a data storage device, the data storage device having an input processing component, a camera control component, and a transaction request generation component comprising non-transitory instructions operative by the computer processor to:
receive a user input from a user indicating initiation of a transaction;
control the camera module to capture an image of the user; and
generate a transaction authorization request, the transaction authorization request including an indication of the transaction and the image of the user.

2. A data processing device according to claim 1, the transaction request generation component further comprising non-transitory instructions operative by the computer processor to generate authentication information for the user, wherein the transaction authorization request further includes an indication of the authentication information.

3. A data processing device according to claim 2, further comprising a biometric reader module, wherein the transaction request generation component further comprises non-transitory instructions operative by the computer processor to generate authentication information by controlling the biometric reader module to capture biometric data of the user.

4. A data processing device according to claim 2, wherein the transaction request generation component further comprises non-transitory instructions operative by the computer processor to generate authentication information using authentication input by the user into the input module.

5. A data processing device according to claim 1, the data storage device further comprising an image analysis component comprising non-transitory instructions operative by the computer processor to analyze the image of the user to determine if the image corresponds to a living human, wherein the transaction request generation component comprises non-transitory instructions operative by the computer processor to generate the transaction authorization request only if the image corresponds to a living human.

6. A data processing device according to claim 1, wherein the camera control component comprises non-transitory instructions operative by the computer processor to control the camera to capture the image of the user in response to the user input indicating initiation of the transaction.

7. A data processing device according to claim 1, the input processing component further comprising non-transitory instructions operative by the computer processor to receive input of a user identifier, wherein the transaction authorization request further includes an indication of the user identifier.

8. A data processing device according to claim 1, further comprising a communication module, wherein the data storage device further comprises an communication control component comprising non-transitory instructions operative by the computer processor to send the transaction authorization request to a transaction processing server from the communication module.

9. A method of generating a transaction authorization request in a data processing device, the method comprising:
receiving, in an input module of the data processing device, a user input from a user indicating initiation of a transaction;
capturing, in a camera module of the data processing device, an image of the user; and
generating, in a transaction authorization request generation component of the data processing device, a transaction authorization request, the transaction authorization request including an indication of the transaction and the image of the user.

10. A method according to claim 9, further comprising generating authentication information for the user, wherein the transaction authorization request further includes, an indication of the authentication information.

11. A method according to claim 10, wherein generating authentication information comprises capturing, in a biometric reader module of the data processing device, biometric data of the user.

12. A method according to claim 10, wherein generating authentication information comprises receiving, in the input module of the data processing device, an input of authentication information from the user.

13. A method according to claim 9, further comprising analyzing the image of the user, in an image analysis component of the data processing device, to determine if the image corresponds to a living human, and generating the transaction authorization request only if the image corresponds to a living human.

14. A method according to claim 9, wherein the capture of the image of the user is triggered in response to the user input indicating initiation of the transaction.

15. A method according to claim 9, further comprising sending the transaction authorization request to a transaction processing server from a network interface of the data processing device.

16. A non-transitory computer readable medium having stored thereon program instructions for causing at least one processor to perform a method according to claim 9.

17. A system for processing a transaction authorization request, the system comprising:
a computer processor and a data storage device, the data storage device having a transaction request processing component, and a transaction record storage component comprising non-transitory instructions operative by the computer processor to:
receive a transaction authorization request, the transaction authorization request including an indication of a transaction and an image of a user captured during initiation of the transaction authorization request; and
store, in a database coupled to the system, a transaction record including the image of the user and the indication of the transaction.

18. A system according to claim 17, wherein the transaction authorization request further includes an indication of a user identifier, and wherein the transaction record further includes an indication of the user identifier.

19. A system according to claim 17, the data storage device further comprising an image comparison component comprising non-transitory instructions operative by the computer processor to compare the image of the user captured during initiation of the transaction authorization request with at a plurality of stored images labeled as relating to fraudulent transactions, wherein the transaction request processing component further comprises non-transitory instructions operative by the computer processor to generate a transaction authorization response indicating that the transaction is declined if the image of the user captured during indication matches one of the images labeled as relating to a fraudulent transaction.

20. A system according to claim 17, wherein the transaction record storage component further comprises non-transitory instructions operative by the computer processor to encrypt the transaction record.

21. A computer implemented method of processing a transaction authorization request, the method comprising:
receiving, at a payment transaction processing server, a transaction authorization request, the transaction authorization request including an indication of a transaction and an image of a user captured during initiation of the transaction authorization request; and
storing, in a database coupled to the payment transaction server, a transaction record including the image of the user and the indication of the transaction.

22. A method according to claim 21, wherein the transaction authorization request includes an indication of a user identifier, and wherein the transaction record further includes an indication of the user identifier.

23. A method according to claim 21, further comprising comparing the image of the user captured during initiation of the transaction authorization request with at least one stored image labeled as relating to fraudulent transactions, and generating a transaction authorization response indicating that the transaction is declined if the image of the user captured during indication matches one of the images labeled as relating to a fraudulent transaction.

24. A method according to claim 21, further comprising encrypting the transaction record.

25. A non-transitory computer readable medium having stored thereon program instructions for causing at least one processor to perform a method according to claim 21.
